(19) United States
(12) Patent Application Publication
(10) Pub. No.: US 2026/0119261 A1
(43) Pub. Date: Apr. 30, 2026

(54) Dynamic Compatibility-Based Device Deployment

(71) Applicant: Zebra Technology Corporation, Lincolnshire, IL (US)

(72) Inventors: Ajay Sood, Bangalore (IN); Sonia B. Thomas, Bangalore (IN); C R Greeshma Reddy, Bangalore (IN)

(73) Assignee: Zebra Technology Corporation, Lincolnshire, IL (US)

(21) Appl. No.: 18/932,581

(22) Filed: Oct. 30, 2024

(51) Int. Cl. G06F 9/50; G06F 21/31

(52) U.S. Cl. CPC G06F 9/5044; G06F 21/31

(57) ABSTRACT

A method includes: receiving a deployment request associated with a device; selecting a profile identifier from a plurality of profile identifiers based on the deployment request, each of the profile identifiers associated with respective device-assisted tasks; retrieving, based on the selected profile identifier, a reference attribute corresponding to the device-assisted tasks associated with the selected profile identifier; obtaining a current attribute corresponding to the device; comparing the reference attribute with the current attribute; and presenting, based on the comparison, an indicator of compatibility between the device and the device-assisted tasks associated with the selected profile identifier.

### BACKGROUND

Mobile computing devices, such as portable computers, barcode scanners, and the like, may be deployed for various tasks or sets of tasks. The performance of each task or set of tasks may involve different device capabilities. A device deployed in an environment with multiple sets of tasks may be compatible with some of the tasks, and incompatible with other tasks.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a system for collective charging control for mobile computing devices.

FIG. 2A is a diagram illustrating certain internal components of a mobile computing device in the system of FIG. 1.

FIG. 2B is a diagram illustrating certain internal components of the server of FIG. 1.

FIG. 3 is a flowchart of a method of dynamic compatibility-based device deployment.

FIG. 4 is a diagram illustrating example performances of block of the method of FIG. 3.

FIG. 5 is a diagram illustrating an example performance of blocks 310 and 315 of the method of FIG. 3.

FIG. 6 is a diagram illustrating an example performance of block 320 of the method of FIG. 3.

FIG. 7 is a flowchart of a method of generating or updating profile data for use in the method of FIG. 3.

FIG. 8 is a diagram illustrating an example performance of blocks 705 and 710 of the method of FIG. 7.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to a method, comprising: receiving a deployment request associated with a device; selecting a profile identifier from a plurality of profile identifiers based on the deployment request, each of the profile identifiers associated with respective device-assisted tasks; retrieving, based on the selected profile identifier, a reference attribute corresponding to the device-assisted tasks associated with the selected profile identifier; obtaining a current attribute corresponding to the device; comparing the reference attribute with the current attribute; and presenting, based on the comparison, an indicator of compatibility between the device and the device-assisted tasks associated with the selected profile identifier.

Additional examples disclosed herein are directed to a computing device, comprising: a communications interface; and a processor configured to: receive a deployment request associated with a device; select a profile identifier from a plurality of profile identifiers based on the deployment request, each of the profile identifiers associated with respective device-assisted tasks; retrieve, based on the selected profile identifier, a reference attribute corresponding to the device-assisted tasks associated with the selected profile identifier; obtain a current attribute corresponding to the device; compare the reference attribute with the current attribute; and present, based on the comparison, an indicator of compatibility between the device and the device-assisted tasks associated with the selected profile identifier.

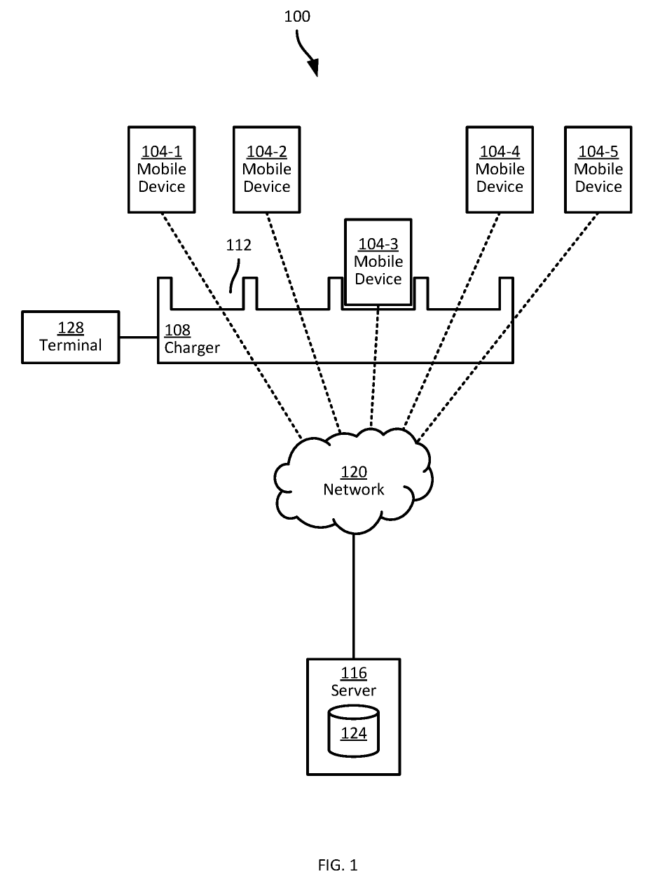

FIG. 1 illustrates a system 100 for dynamic compatibility-based deployment of devices, such as a plurality of mobile computing devices 104-1, 104-2, 104-3, 104-4, and 104-5, which are also collectively referred to herein as mobile computing devices 104 or devices 104, and generically as a mobile computing device 104 or a device 104. Similar nomenclature (a reference number with a hyphenated suffix) may also be used elsewhere herein to refer to multiple instances of an element. The devices 104 can be of various types, including any one of, or any combination of, mobile computers (e.g., with handheld form factors, wearable form factors, or the like), tablet computers, barcode scanners, mobile printers, and the like. The devices 104 can be deployed in a wide variety of environments, including transport and logistics facilities (e.g., warehouses, airport cargo facilities, and the like), manufacturing facilities, and the like. The system 100 can include other numbers of devices 104 than the five shown in FIG. 1. For example, a given facility may include hundreds or thousands of devices.

The devices 104 can be deployed in a facility to perform any of a variety of tasks, including for example barcode scanning or other data capture, e.g., to support picking operations in a shipping facility. The devices 104 may be deployed in one or more pools, e.g., in respective areas of the facility. For example, the devices 104 (or a set of devices 104 among the total number of devices 104 in the facility) can be disposed in one or more staging areas, for retrieval by staff at the facility and use during the above-mentioned tasks.

Devices 104 may be retrieved at the beginning of a time period such as a shift, e.g., by staff assigned to that shift. The devices 104 may then be returned to the staging area(s) at the end of the shift, e.g., for use during a later shift. A given device 104 may be selected for use by any of a wide variety of staff members at the facility. That is, there may not be any specific associations between devices 104 and staff members. Further, the tasks for which a device 104 can be operated can vary. For example, staff in the facility may perform multiple distinct roles, with each role including a given set of tasks (e.g., distinct implementations of data entry, barcode capture, and the like). Staff may retrieve the devices 104 from a given staging area for use in performing multiple roles. That is, there may also not be a specific association between devices 104 and roles (e.g., sets of tasks) performed in the facility.

Each device 104 can be powered by a rechargeable battery, e.g., a lithium-ion battery (other battery chemistries can also be employed, however). The devices 104 can be connected to one or more chargers 108 when not in use. The charger 108 can be disposed in the staging area mentioned above, in some examples. The charger 108 includes a plurality of cradles 112 each configured to receive a device 104 (as shown with the device 104-3 in FIG. 1) and connect a port or other electrical contact of the device 104 with a power supply of the charger 108. Various other forms of the charger 108 can also be provided in other examples, including cables configured to plug into the devices 104, chargers 108 with single cradles (e.g., rather than a charger 108 that can accommodate multiple devices 104 as shown in FIG. 1), and the like.

As will be apparent, when a device 104 is removed from a cradle 112 (or otherwise disconnected from charging infrastructure in the facility), e.g., at the start of a shift or other period of deployment in the facility, the device 104 may be in use for several hours without an external power supply. If the battery of the device 104 does not have sufficient energy stored to power the device 104 during the deployment period, operations involving the device 104 (e.g., the picking operations mentioned above) may be interrupted to charge the device 104, or to retrieve another device 104 during the deployment period. Further, as discussed below, the devices 104 may have various software applications installed thereon, and different roles performed by staff in the facility may involve the use of different software applications on the devices 104. Devices 104 that lack certain applications may be incompatible with the tasks involved in performing some roles (e.g., a device lacking a shipping application may be incompatible with a role that involves preparing items for shipping and documenting outgoing shipments from the facility). Determining, e.g., by a staff member, which applications are installed on a given device in the charger 108, may be difficult and/or time consuming. Selecting a device 104 from the charger 108 that is incompatible for the role to be performed by the operator of the device 104 may lead to interruptions in operations at the facility, e.g., to exchange a device 104 with a depleted battery and/or with a software configuration incompatible with a given role.

The above-mentioned interruptions are costly and inefficient. Avoiding selection of an inappropriate device for a given role (and thus avoiding such interruptions), however, presents certain technical problems. For example, a staging area may include tens or hundreds of devices 104, and manually reviewing the available software and/or battery level of each device is prohibitively time-consuming. Further, even if such a review were to be performed, the power demand of a given role may not be evident to staff members, and may vary over time (e.g., seasonally). The software involved in performing a given role may also not be readily evident to staff members.

The system 100 includes components that implement functionality to characterize the above-mentioned roles, e.g., by autonomously determining and/or updating reference attributes of the roles, such as software requirements and power demand for each role. The system 100 further implements functionality to automatically determine whether a given device 104 is compatible with a given role. The system 100 can therefore provide device selection guidance to staff members, reducing the likelihood that a staff member retrieves a device 104 poorly suited to the role assigned to that staff member.

The system 100 includes a server 116, e.g., connected with the devices 104 via a network 120 (e.g., any one of, or any combination of, local area networks and wide area networks). The server 116 is configured to receive data from the devices 104, e.g., for preprocessing and/or storage in a repository 124. The server 116 is further configured to generate and/or update reference attributes for roles performed with the devices 104 at the facility. The reference attributes can include either or both of software applications required for performing a given role, and a power demand (e.g., which can be compared to battery charge levels) imposed on the devices 104 for performing the role.

By retrieving current attributes of one or more of the devices 104 (e.g., a current battery level, and/or a current set of software applications installed on a device 104), and comparing the current attributes to the reference attributes, the server 116 can determine whether a given device 104 is compatible with a given role. The server 116 can present a compatibility indicator resulting from the above comparison, e.g., indicating whether a specific device 104 is compatible with a given role, or indicating one or more of the devices in the staging area (e.g., on the charger 108) that is/are compatible with the role. The indication can be presented on a device 104, or on a terminal 128 associated with the charger 108. The terminal 128 can be a fixed computing device, e.g., physically coupled with the charger 108 or nearby the charger 108. The terminal 128 can include, for example, a display and a keypad or other input device, and can be configured to transmit requests to the server 116 to perform compatibility determinations for one or more of the devices in the charger 108. The terminal 128 can be used, for example, to guide a staff member to select a compatible device 104 from the charger 108.

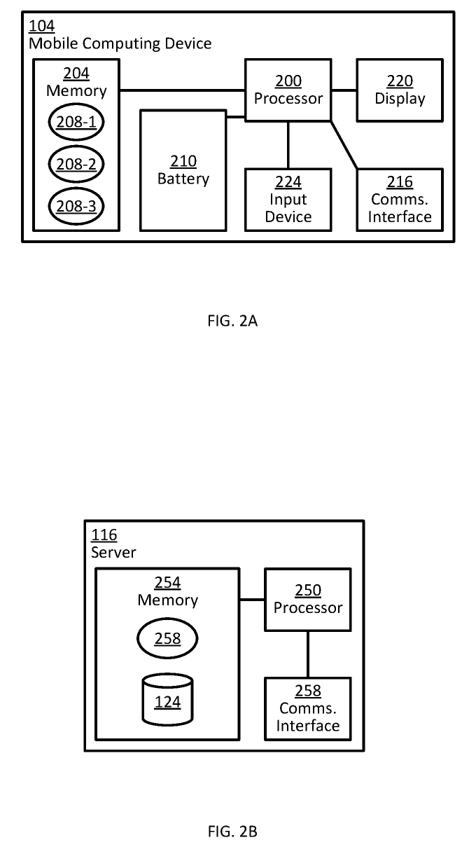

Turning to FIGS. 2A and 2B, before discussing the functionality of the devices 104 and the server 116, certain internal components of the devices 104 and the server 116 are discussed. FIG. 2A illustrates internal components of a device 104. Although the devices 104 may have various form factors and specific instances of the components shown in FIG. 2A, each device 104 includes a functional equivalent to the components shown in FIG. 2A.

The device 104 includes a processor 200, such as a central processing unit (CPU), graphics processing unit (GPU), application-specific integrated circuit (ASIC), or the like. The processor 200 is communicatively coupled with a non-transitory computer-readable storage medium such as a memory 204, e.g., a combination of volatile memory elements (e.g., random access memory (RAM)) and non-volatile memory elements (e.g., flash memory or the like). The memory 204 stores a plurality of computer-readable instructions in the form of applications 208-1, 208-2, and 208-3. The device 104 can store more than the three illustrated applications 208, in other examples. The applications 208 can implement a wide variety of functionality, including data collection, communications (e.g., for messaging, audio and/or video calling, or the like), geolocation, and the like. Certain applications 208 may configure the device 104 to collect and report activity data to the server 116.

The device 104 also includes a battery 210, e.g., a rechargeable battery electrically connected to the processor 200, which may implement power supply functionality for the device 104. In other examples, the battery 210 can also be connected to other components of the device 104, in addition to or instead of the processor 200.

The device 104 also includes a communications interface 216, enabling the device 104 to communicate with other computing devices, including the server 116, e.g., via the network 120. The device 104 can also include one or more output devices, such as a display 220, and one or more input devices 224, such as a touch screen, sensors (e.g., a camera, a barcode scanning assembly, and/or other inputs) or the like.

FIG. 2B illustrates internal components of the server 116. The server 116 includes a processor 250, such as a central processing unit (CPU), graphics processing unit (GPU), application-specific integrated circuit (ASIC), or the like. The processor 250 is communicatively coupled with a non-transitory computer-readable storage medium such as a memory 254, e.g., a combination of volatile memory elements (e.g., random access memory (RAM)) and non-volatile memory elements (e.g., flash memory or the like). The memory 254 stores a plurality of computer-readable instructions in the form of applications, including in the illustrated example a compatibility assessment application 258, whose execution by the processor 250 configures the server 116 to generate and/or update reference attributes corresponding to roles performed in the facility, and to determine whether one or more devices 104 are compatible with a given role.

The server 116 also includes a communications interface 260, enabling the server 116 to communicate with other computing devices, including the devices 104, e.g., via the network 120. The server 116 can be implemented as a single physical computing device. In other examples, the server 116 can be implemented in a distributed manner, e.g., with one or more networked physical computing devices being logically associated to implement the functionality described below in connection with the server 116.

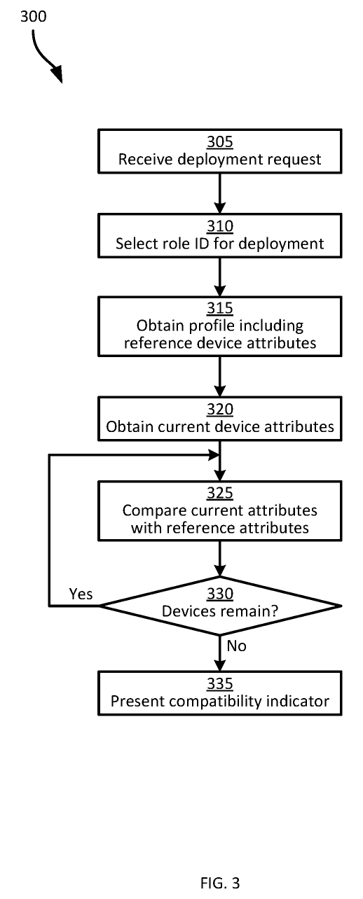

Turning to FIG. 3, a method 300 of dynamic compatibility-based device deployment is illustrated. The method 300 is described below in conjunction with its performance at the server 116, e.g., via execution of the application 258 by the processor 250. In other examples, certain blocks of the method 300 can be performed by one or more of the devices 104, and/or by the terminal 128, as noted below.

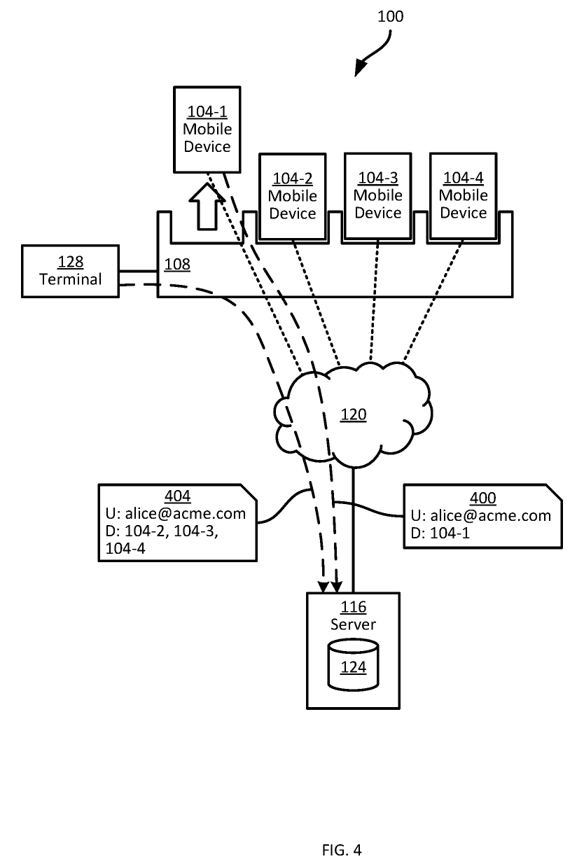

At block 305, the server 116 is configured to receive a deployment request associated with one or more of the devices 104. The deployment request can take various forms. Turning briefly to FIG. 4, for example, two example deployment requests are illustrated. A staff member (e.g., also referred to as an operator or a user of the devices 104) can withdraw a device 104, e.g., the device 104-1 in the example shown in FIG. 4, from the charger 108. The devices 104 can be configured to prompt users for authentication data such as an account identifier (in some cases, accompanied by a password, biometric data, or the like). In response to receiving an account identifier or other suitable identifier of the staff member, the device 104-1 can be configured to send a deployment request 400 to the server 116. The request 400 includes, in the illustrated example, a device identifier such as a media access control (MAC) address, a serial number of the device 104-1, or the like. The request 400 also includes an identifier of the user (e.g., the account identifier “alice@acme.com” in this example).

FIG. 4 also illustrates a deployment request 404, generated by the terminal 128. For example, a staff member can provide their authentication data at the terminal 128 prior to selecting any device 104 from the charger 108. The terminal 128, in response to authenticating the staff member, can determine the identifiers of the devices 104 in the charger 108, and send a deployment request 404 including the above-mentioned user identifier. The request 404 also includes a plurality of device identifiers in this case, identifying the devices 104-2, 104-3, and 104-4.

Returning to FIG. 3, at block 310, the server 116 is configured to select a profile identifier, also referred to herein as a role identifier, based on the deployment request from block 305. The profile identifier is selected from a plurality of predetermined profile identifiers, each of which is associated with certain device-assisted tasks in the facility. The device-assisted tasks can include a wide variety of operations performed by the devices 104 and/or by users of the devices 104, including scanning barcodes or other data capture operations, printing labels, documenting the locations of items such as parcels, and the like. The above tasks can be organized into roles, and a role can be assigned to each staff member in the facility, e.g., for a given shift or other suitable time period. For example, an “inventory” role may include a set of tasks related to counting inventory in a retail store, while a “receiving” role may include a set of tasks related to processing inventory received at the facility, e.g., before moving the inventory into stock.

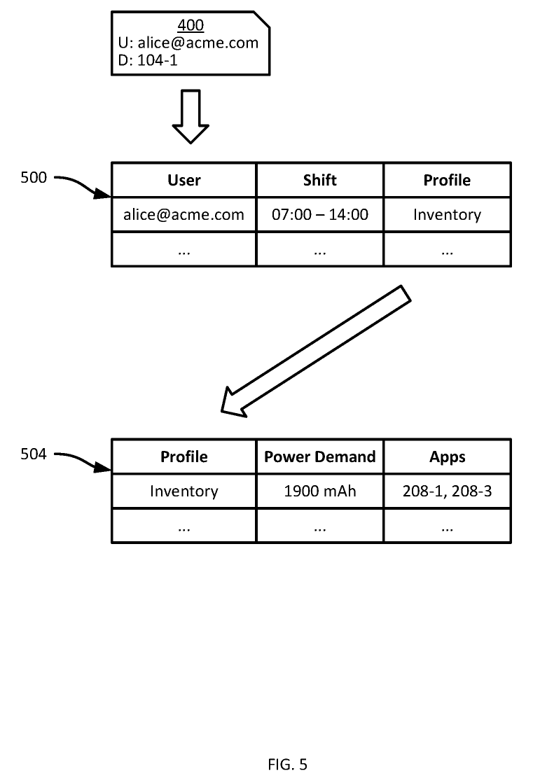

The server 116 can be configured to select a profile identifier at block 310 based on the user identifier in the request (e.g., the request 400 or 404) from block 305. Turning to FIG. 5, the server 116 can store, e.g., in the repository 124, account records 500 including identifiers (e.g., “alice@acme.com”), and associated information such as one or more deployment periods or shifts, and a role or profile assigned to the user for each deployment period. For example, FIG. 5 illustrates a record indicating that for a shift extending from 7 am to 2 pm, the user associated with the account “alice@acme.com” is assigned to the role “inventory”. The server 116 can therefore retrieve the role identifier “inventory” at block 310, using the account identifier from the request 400 or 404. In some examples, the deployment request from block 305 can include a profile identifier, e.g., selected at the device 104 or at the terminal 128.

Referring again to FIG. 3, at block 315 the server 116 is configured to obtain a reference attribute corresponding to the device-assisted tasks that are associated with the profile identifier from block 310. In other words, the profile associated with a given user in the account records 500 is indicative of various tasks that the user is expected to perform. Performing those tasks may impose certain requirements on a device 104 employed by the user. The requirements can include hardware resources (e.g., a device 104 without a barcode reader may be unable to fulfill the role) and/or software applications. The requirements can also include an expected power demand for the device 104 during the deployment period. As will be apparent to those skilled in the art, certain roles may impose greater power consumption on the devices 104 than other roles, e.g., due to environmental conditions, software applications executed during performance of the roles, and the like. The requirements mentioned above can also be referred to as reference attributes.

The server 116 can be configured to retrieve the reference attributes at block 315 from profile data stored in the repository 124. For example, referring again to FIG. 5, the repository 124 can include one or more profile records 504, each including a profile identifier (e.g., “Inventory”), and one or more reference attributes. In the example shown in FIG. 5, the reference attributes include a power demand, e.g., expressed in mAh, although various other measures of power demand can also be employed. The reference attributes also include identifiers of one or more software applications, e.g., the applications 208-1 and 208-3 in the example of FIG. 5. Each profile record can also include reference attributes corresponding to hardware resources in some examples, e.g., to indicate that a certain role involves the use of a time-of-flight camera (which may indicate that devices 104 lacking such a camera may be incompatible with that role).

In other examples, the profile records 504 can include distinct sets of reference attributes for each of a plurality of device 104 models, or the like. For example, to perform the same role, two different device models may use different versions of a given software application.

Returning to FIG. 3, at block 320 the server 116 is configured to obtain current device attributes, from the device 104 identified in the deployment request from block 305, or multiple devices 104, if the request from block 305 identified more than one device 104. While the reference attributes indicate expected capabilities of a device 104 for the relevant profile, the current attributes indicate actual capabilities of each device 104 under consideration. As will be apparent, the actual capabilities of a device 104 may not satisfy the expected capabilities represented by the reference attributes.

Obtaining the current device attributes can include sending a request, e.g., from the server 116 to the device 104, identifying the attributes. For example, in response to the request 400 shown in FIG. 4, at block 315 the server 116 can send a request to the device 104-1 for a current battery charge level of the device 104-1 and identifiers of applications currently installed at the device 104-1. In other examples, the deployment request from block 305 can include the current attributes, such that obtaining the current attributes at block 320 includes retrieving the current attributes from the request 400 or the request 404.

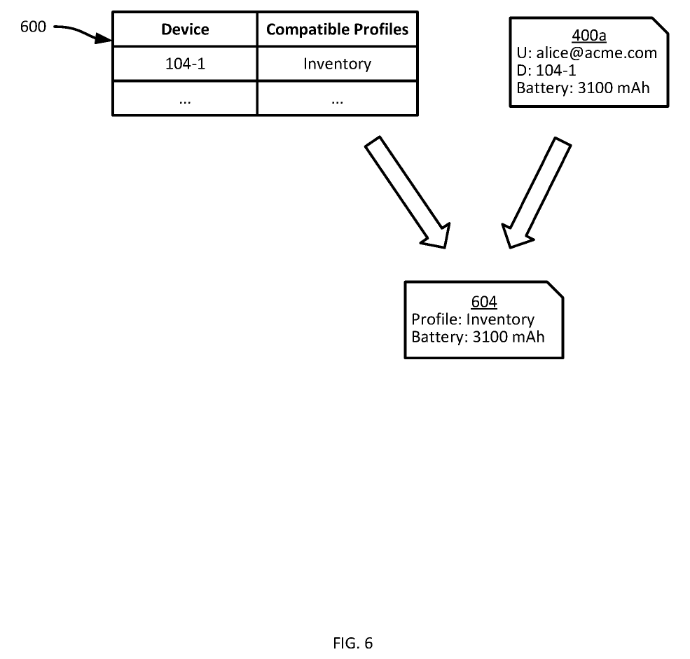

In some examples, the server 116 can be configured to obtain the current attributes at block 320 from more than one source. For example, a current battery charge level of a device 104 (or multiple devices 104, depending on the contents of the request from block 305) can be retrieved from the request 400 or 404. In addition, the server 116 can be configured to store, e.g., in the repository 124, indications of which profile(s) each device 104 is compatible with based on software applications installed at the device 104 and/or hardware capabilities of the device 104. For example, as shown in FIG. 6, the server 116 can maintain a list 600 of device identifiers and corresponding profile identifiers, e.g., from previous assessments of whether each device 104 includes the software applications associated with the profile identifiers. For example, the inclusion of the profile identifier “Inventory” in connection with the device 104-1 in the list 600 indicates that the device 104-1 has the applications 208-1 and 208-3 installed thereon. The list 600 can be populated during the generation or updating of reference attributes for the profile identifiers, as discussed further below.

FIG. 6 also illustrates another deployment request 400a, including a current (e.g., at the time the device 104-1 sent the request 400a) battery charge level for the device 104-1. The server 116 can, at block 320, retrieve the battery level (e.g., 3100 mAh as shown in FIG. 6) from the request 400a, and the profile identifier “Inventory” from the list 600 to obtain current attributes 604 of the device 104-1.

Returning to FIG. 3, at block 325 the server 116 is configured to compare the current attributes from block 325 with the reference attributes from block 315. The server 116 is configured to determine whether the current attributes meet or exceed the requirements indicated by the reference attributes. For example, the server 116 can be configured to determine whether the device 104 includes the software applications indicated in the reference attributes, and whether the current battery charge level of the device 104 meets or exceeds the expected power demand from the reference attributes. The server 116 can be configured, at block 330, to determine whether current attributes for any further devices 104 remain to be evaluated, e.g., if the request from block 305 included multiple device identifiers. When the determination at block 330 is affirmative, the server 116 can compare the next set of current attributes to the reference attributes, e.g., repeating block 325. When the determination at block 330 is negative, the server 116 is configured to proceed to block 335.

At block 335, the server 116 is configured to present a compatibility indicator based on the comparison(s) at block 325. For example, when the comparison indicates that the current attributes satisfy the reference attributes, the compatibility indicator can include a message to the device 104-1 (e.g., in response to the request 400 or the request 400a) indicating that the device 104-1 is suitable for use. The message can be presented on the display 220 of the device 104-1, via a speaker of the device 104-1, or the like.

When the comparison indicates that the current attributes do not satisfy the reference attributes, the compatibility indicator can include a message indicating that the device 104-1 is not suitable for use. The message can be presented on the display 220, e.g., instructing the user to select a different device 104. In some examples, the server 116 can be configured to select from among a plurality of messages based on which current attributes do not satisfy the reference attributes. For example, if the device 104-1 includes the software applications indicated by the reference attributes, but has an insufficient battery charge level, the compatibility indicator presented at block 335 can instruct the user to proceed with the device 104-1, and to also retrieve a spare battery from a supply of batteries.

When the request at block 305 is received from the terminal 128, for example, the server 116 can present the compatibility indicator at block 335 by sending a message to the terminal 128 to display an indication of which cradles 112 contain compatible devices 104. In other examples, the server 116 can control the charger 108, e.g., to enable indicator lights or the like associated with the cradles 112 currently housing devices 104 that are compatible with the reference attributes.

In some examples, a device 104 can perform blocks 315, 320, 325 and 335. For example, in response to being withdrawn from the charger 108, the device 104-1 can determine a profile identifier via a request to the server 116 at block 315, and can also request the reference attributes from the server 116 at block 320. The device 104-1 can then perform the comparison at block 325, and generate a compatibility indicator at block 335, e.g., instructing the user to proceed with use of the device 104-1, or to select a different device 104.

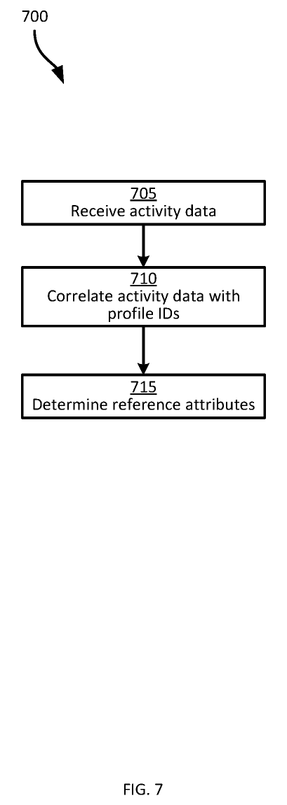

Turning to FIG. 7, a method 700 of generating and/or updating reference attributes associated with profile identifiers is illustrated. The method 700 can be performed periodically by the server 116, e.g., to autonomously discover reference attributes, thus mitigating the need for such attributes to be configured and periodically updated manually.

At block 705, the server 116 is configured to receive activity data from the devices 104. The devices 104 can be configured to report telemetry data to the server 116 via the network 120 periodically. For example, the activity data can include battery charge levels at the start and end of deployment periods (e.g., when a device 104 was withdrawn from the charger 108, and when the device 104 was replaced on the charger 108). The activity data can include, in other examples, an amount of power consumed (e.g., in mAh) during the deployment period, in addition to or instead of the battery charge levels.

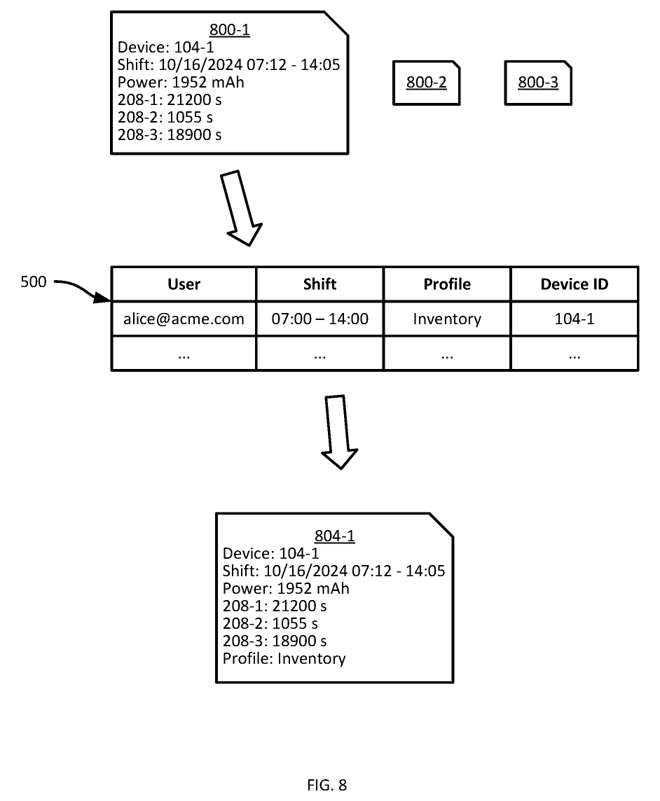

The activity data can also include, for a deployment period (e.g., a shift as noted above), a time period that a given software application was executed on the device 104. The time period can indicate, for example, a number of seconds during the deployment period that the software application was actively executed. Turning to FIG. 8, example activity data 800-1 indicates a deployment period (“shift”) for the device 104-1, as well as an amount of power consumed by the device 104-1 during the deployment period, and activity periods in seconds for each of the applications 208-1, 208-2, and 208-3. The server 116 can receive a plurality of activity data records 800, from a plurality of devices 104, e.g., including records 800-2 and 800-3. The server 116 can also generate the records 800 from a plurality of records each containing partial activity data.

Referring again to FIG. 7, at block 710 the server 116 is configured to correlate the activity data with profile identifiers, e.g., by referring to the account records 500 mentioned earlier. The account records 500 can include timestamps associated with role assignments, including historical role assignments, and can also include identifiers of devices 104 employed by the users during such time periods. The server 116 can therefore be configured to determine which role was associated, for example, with the device 104-1 while the activity data 800-1 was received. The role identifiers correlated with activity data at block 710 effectively label the activity data. FIG. 8 illustrates a labelled activity data record 804-1, generated from the record 800-1 based on the account records 500.

At block 715, the server 116 is configured to determine reference attributes for each profile identifier based on the labelled activity data from block 710. Determining the reference attributes can include, for example, aggregating a plurality of activity records 800 associated with each profile identifier over a time period such as a week, a month, or the like. From the aggregated activity data for a given profile identifier, the server 116 can determine a power demand reference attribute by, for example, determining the 95^{th} percentile (or any other suitable measure) among the power consumption data in the activity records 800.

The server 116 can also be configured to identify software applications associated with the profile identifier by, for example, filtering out predetermined applications (e.g., represented in a list stored at the server 116) designated as not being related to operations in the facility. Filtered applications can include applications integrated into device operating systems, such as photo gallery applications or the like. The server 116 can then be configured to rank the applications in the aggregated activity data, and to select a predefined number of top-ranked applications 208 by activity. In other examples, the server 116 can be configured to select any application 208 that was executed by at least a threshold proportion (e.g., 80% or any other suitable threshold) of the activity records 800 corresponding to a given profile identifier. In further examples, the server 116 can be configured to select any application 208 for which at least a threshold proportion of the devices 104 reported an execution time above a secondary threshold (e.g., at least 2000 seconds (s) per hour on average, or any other suitable threshold). The server 116 is configured to store identifiers of the selected applications 208 in the profile data.

The server 116 can be configured to perform the method 700 periodically, e.g., monthly, once per quarter, or the like, such that the profile data 504 is updated to reflect changes in seasonal demand at the facility, changes in deployed applications, or the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
receiving a deployment request associated with a device;
selecting a profile identifier from a plurality of profile identifiers based on the deployment request, each of the profile identifiers associated with respective device-assisted tasks;
retrieving, based on the selected profile identifier, a reference attribute corresponding to the device-assisted tasks associated with the selected profile identifier;
obtaining a current attribute corresponding to the device;
comparing the reference attribute with the current attribute; and
presenting, based on the comparison, an indicator of compatibility between the device and the device-assisted tasks associated with the selected profile identifier.

2. The method of claim 1 ,wherein receiving the deployment request includes:
receiving a message generated by the device responsive to authentication of an operator at the device.

3. The method of claim 1, wherein receiving the deployment request includes:
receiving a message from a terminal associated with a plurality of devices, the plurality of devices including the device.

4. The method of claim 3, further comprising:
obtaining respective current attributes from each of the plurality of devices;
comparing the reference attribute to each of the respective current attributes;
wherein the indicator of compatibility includes an identifier of one of the plurality of devices.

5. The method of claim 1, wherein the reference attribute includes a power demand corresponding to the profile identifier;
wherein the current attribute includes a current battery level of the device; and
wherein comparing the reference attribute with the current attribute includes determining whether the current battery level exceeds the power demand.

6. The method of claim 1, further comprising: storing an association between an identifier of the device and at least one of the profile identifiers;
wherein the comparison includes determining whether the at least one of the profile identifiers associated with the identifier of the device matches the selected profile identifier.

7. The method of claim 1, further comprising:
storing one of the profile identifiers in association with an operator identifier;
wherein the deployment request includes the operator identifier; and
selecting the profile identifier based on the stored association between the one of the profile identifiers and the operator identifier.

8. The method of claim 1, further comprising:
obtaining activity data from the device indicating a time period that a software application was executed on the device;
correlating the activity data with a first profile identifier of the plurality of profile identifiers; and
updating the reference attribute associated with the first profile identifier

9. The method of claim 8, wherein correlating the activity data with the first profile identifier of the plurality of identifiers includes:
determining an operator identifier associated with the device during the time period; and
retrieving the first profile identifier based on the operator identifier.

10. A computing device, comprising:
a communications interface; and
a processor configured to:
receive a deployment request associated with a device;
select a profile identifier from a plurality of profile identifiers based on the deployment request, each of the profile identifiers associated with respective device-assisted tasks;
retrieve, based on the selected profile identifier, a reference attribute corresponding to the device-assisted tasks associated with the selected profile identifier;
obtain a current attribute corresponding to the device;
compare the reference attribute with the current attribute; and
present, based on the comparison, an indicator of compatibility between the device and the device-assisted tasks associated with the selected profile identifier.

11. The computing device of claim 10, wherein the processor is configured to receive the deployment request by:
receiving a message generated by the device responsive to authentication of an operator at the device.

12. The computing device of claim 10, wherein the processor is configured to receive the deployment request by:
receiving a message from a terminal associated with a plurality of devices, the plurality of devices including the device.

13. The computing device of claim 12, wherein the processor is configured to:
obtain respective current attributes from each of the plurality of devices;
compare the reference attribute to each of the respective current attributes;
wherein the indicator of compatibility includes an identifier of one of the plurality of devices.

14. The computing device of claim 10, wherein the reference attribute includes a power demand corresponding to the profile identifier;
wherein the current attribute includes a current battery level of the device; and
wherein the processor is configured to compare the reference attribute with the current attribute by determining whether the current battery level exceeds the power demand.

15. The computing device of claim 10, wherein the processor is configured to:
store an association between an identifier of the device and at least one of the profile identifiers;
wherein the comparison includes determining whether the at least one of the profile identifiers associated with the identifier of the device matches the selected profile identifier.

16. The computing device of claim 10, wherein the processor is configured to:
store one of the profile identifiers in association with an operator identifier;
wherein the deployment request includes the operator identifier; and
select the profile identifier based on the stored association between the one of the profile identifiers and the operator identifier.

17. The computing device of claim 10, wherein the processor is configured to:
obtain activity data from the device indicating a time period that a software application was executed on the device;
correlate the activity data with a first profile identifier of the plurality of profile identifiers; and
update the reference attribute associated with the first profile identifier

18. The computing device of claim 17, wherein the processor is configured to correlate the activity data with the first profile identifier of the plurality of identifiers by:
determining an operator identifier associated with the device during the time period; and
retrieving the first profile identifier based on the operator identifier.
